(19) United States
(12) Patent Application Publication
(10) Pub. No.: US 2015/0096944 A1
(43) Pub. Date: Apr. 9, 2015

(54) METHOD AND SYSTEM FOR RECOVERING AND PROCESSING BULK MATERIALS

(71) Applicants: Arie Krush, Kfar-Saba (IL); Bruce Vandenberg, Ascot (GB)

(72) Inventors: Arie Krush, Kfar-Saba (IL); Bruce Vandenberg, Ascot (GB)

(21) Appl. No.: 14/509,124

(22) Filed: Oct. 8, 2014

Related U.S. Application Data
(60) Provisional application No. 61/888,079, filed on Oct. 8, 2013.

(51) Int. Cl. B07B 1/00; E21B 21/06; B07B 1/28

(52) U.S. Cl. CPC B07B 1/005; B07B 1/28; E21B 21/065
USPC 210/780; 209/240

(57) ABSTRACT

A portable, self-contained screening module for processing a bulk material in-feed and methods thereof are disclosed. The screening module may comprise: an inlet arranged to receive the material in-feed; at least one screening assembly arranged to separate particles having a predetermined size classification from the material in-feed; a material outlet arranged to discharge processed material; and a waste outlet arranged to discharge the separated particles. A modular containerized bulk material recovery system for processing a material in-feed which includes such a screening module is also disclosed.

### TECHNICAL FIELD

The following disclosure relates to techniques, systems and methods for the recovery and processing of bulk materials, and particularly to the processes of screening, grading and classification of such substances.

### BACKGROUND

Industrial mining of bulk materials such as ores and coal involves bulk material handling processes to crush, grade and classify the mined substances into usable fractions.

Taking coal mining as an example, the process of separating coal from rock is done in a coal preparation plant which is a facility that washes the soil and rock from the mined coal, crushes the coal into smaller sized pieces and grades the crushed coal in preparation for shipping.

Grading of the coal into predetermined size fractions typically involves gravity separation. The effectiveness of gravity separation technologies relies on screening to provide as homogenous a feed as possible so that the difference in specific gravity of the coal and the rock is maintained at a particular level as it goes through whichever gravity process is being used. Some processes use a heavy liquid medium which is selected for its specific gravity so that coal floats and rock sinks in the liquid, which may be, for example, a magnetite liquid. Other technologies use centrifugal forces to separate the coal from rock.

The specific gravity of coal varies according to the nature of the coal seam from which it originates. Also, when dealing with smaller particles other factors come into play, such as the electro-static forces between the fine coal and fine rock particles. This reduces the effectiveness of using specific gravity as a separation means, and also reduces the effectiveness of downstream screening technologies. There is a point at which coal can no longer be separated from rock because the particle sizes are too fine and gravity based technologies become ineffective.

For centuries the processes of separating coal through gravity have improved, however in all this time a vast volume of coal in small fractions has been discarded into slurry impoundments as waste.

The recovery of the fine fractions using screening technologies is not commercially viable using equipment that is currently available on the market. Similarly, the screening of fine fractions from a bulk liquid in-feed is also not viable at present. One particular application where this is of relevance is in the processing of used drilling fluid, namely fluid used to assist in drilling, for example, boreholes, which is also referred to as ‘drilling mud’. These fluids are used to carry cuttings up to the surface to remove them from the hole and therefore prevent obstruction of the drilling equipment. The fluid also serves to cool and lubricate the drilling equipment, and to provide a level of support. The cuttings are of a wide range of sizes, some of which are extremely fine. To reuse the fluid, the vast majority of these cuttings must be removed to avoid damage to drilling equipment.

At present, drilling fluid must be processed in multiple stages. In a first stage the fluid is passed through a ‘shale shaker’ which removes the largest cuttings from the fluid. Semi-processed fluid is then fed to mud tanks where other solid control equipment performs further filtration to remove the finer particles.

Another consideration relevant to this field is that conventional screening systems are bulky and complicated, meaning that they are time-consuming to transport and set up. This means that valuable time is wasted on site while such systems are configured before they can become operational. This is of particular importance when it is noted that screening systems are routinely moved from one site to another, in which case there is additional wasted time as the system is disassembled, and then reassembled at the next site. These issues are compounded when the screening systems are used in combination with related systems, as is the case for processing used drilling fluid for example.

### SUMMARY

It is against this background that the various embodiments of the present invention have been devised.

For example, according to an aspect of the invention, there is provided a portable, self-contained screening module for processing a bulk material in-feed. The screening module comprises an inlet arranged to receive the material in-feed, at least one screening assembly arranged to separate particles having a predetermined size classification from the material in-feed, a material outlet arranged to discharge processed material, and a waste outlet arranged to discharge the separated particles.

By virtue of the fact that the screening module is self-contained and portable, it can be moved to a new site and set up rapidly, thereby reducing costs and improving operational efficiency.

The material in-feed may include dry granular substances, such as may be output as waste from an ore mining operation or powder manufacturing plants for instance, or may include wet granular substances such as a coal slurry as may be output as waste from, for example, a coal mining operation. A further example is drilling fluid, sometimes referred to as ‘mud’ that is used in geotechnical engineering operations to drill boreholes into the earth for example for gas or oil extraction. As is known in the art, drilling fluids serve to lubricate and cool the drill bit and also function to convey the drilled cuttings away from the bore hole. The drilling fluids are typically a mixture of various chemicals in either a water-based or an oil-based solution. For environmental and economic reasons, it is desirable to minimize waste of drilling fluid by stripping the fluid away from the cuttings before disposing the cuttings. The cuttings comprise multiple size fractions and it is problematic to screen the drilling fluid of very fine cuttings.

Beneficially, since it is self-contained, the screening module can be set up readily as desired, for example it may be installed on the bank of a slurry pond or coal impoundment, or it may be mounted onto a existing coal wash plant, or mounted onto the superstructure of a drilling rig ready to receive drilling fluid from an in-line feed or a storage tank.

The or each screening assembly of the module may be arranged to apply multifrequency vibration to the material in-feed to separate particles. By applying such a vibrational characteristic the separation efficiency of the screening assembly, and therefore also of the module, is greatly benefitted.

The module may comprise two or more screening assemblies, each of which is arranged to separate particles according to a respective size classification. In one embodiment, the respective size classification may be the same for each screening assembly, although for an alternative embodiment, each respective size classification is different to the others. Within the screening module, the screening assemblies may be arranged in sequence such that the output/discharge of a first screening assembly is fed onto the input/inflow of a second of the screening assemblies. In this scenario, therefore, the in-feed material may be sized in successively small classifications as it progresses from one screening assembly to the next.

The screening module may include a product outlet from which particles of a target size may be discharged. Beneficially, the discharge may then be stored for further processing or re-use. For example, coal fines that have been recovered from slurry using this process may be stored for briquetting thereby yielding saleable product from a source that has up to now been considered waste. Similarly, drilling mud processed in this way may be stored in a tank for re-use in a subsequent drilling operation.

The screening module may be configured with two processing circuits, either arranged in series or parallel. Each of the circuits may have one or more respective screening assemblies and may be controllable independently of each other. This provides a greater degree of control over the flow rate of material through the circuits, and also through the screening module as a whole.

The or each screening assembly may have a working screen that has a mesh that is sized to separate particles according to the predetermined size classification. Particularly, although not exclusively, for fine mesh sizes optionally the working screen may be supported on a support screen, thereby increasing durability.

Spray nozzles may be arranged to spray liquid onto the or each screening assembly. This may improve the flow of the material over the screening assembly and enhance the washing of the material and also the recovery of the final product.

The screening module may comprise a container in which the at least one screening assembly is arranged, along with any ancillary equipment to power the assembly, supply it with material and to discharge material from the module, thereby making a self-contained unit.

In one embodiment, the container may be in the form of an open lattice-like frame to support the screening assembly and other equipment. Such an open frame may be made from suitable structural metal tubing, for example, and is particularly suited to dry weather environments and, helpfully, allows maintenance and operating personnel ready access to the equipment inside it. A benefit of such a container is that it may be sized for a particular application since it may be, essentially, bespoke.

An alternative is for the container to be a standardized shipping container, also known as an ‘intermodal’ container which, beneficially, provides weather protection for the equipment housed within it, and provides a standardized platform for transportation across countries and continents.

The screening module described above may form part of a modular containerized bulk recovery system for processing a material in-feed. Providing a modularized system enables a complete treatment facility to be rapidly set up on a site to be treated. Similarly, the containerized system enables a treatment facility to be disassembled rapidly which minimizes the environmental impact. In addition to the screening module, the system may also include i) a buffer module including a buffer inlet arranged to connect to the material outlet of the screening module, ii) storage unit/means, and iii) a buffer outlet. The buffer module is arranged to direct processed material received at the buffer inlet to the storage unit and to discharge stored material to the buffer outlet on demand. In the same way as the screening module, the buffer module may be housed in a suitable container.

The system may also comprise a portable, self-contained regulator module positioned upstream of the screening module. The regulator module may by physically connected to, or spaced from, the screening module and be arranged to regulate the material in-feed to the screening module. Once again, the regulator module may be housed in a container as described above.

In another aspect, an embodiment of the invention may also be expressed as a method for processing used drilling fluid to enable re-use of the fluid, the method comprising: receiving a flow of used drilling fluid; feeding the fluid flow to a screening system; separating particles having a predetermined size classification from the fluid flow using multifrequency vibration; and discharging processed drilling fluid.

The use of multifrequency vibration increases the performance of the particle size separation compared with known systems. This is a distinct advantage in the stated application of processing drilling fluid, as there are significant economic and environmental benefits to the reuse of drilling fluid. By virtue of applying multifrequency separation to the drilling fluid, embodiments of the invention enables a higher flow rate of the drilling fluid to be processed, with a lower maintenance burden.

In some embodiments, the step of separating particles includes feeding the fluid flow onto a screen of the screening system, and applying transient impact forces to the screen to induce multifrequency oscillations in the screen that excite the particles. The transient impact forces are delivered by one or more vibrational adaptors that are excited by single frequency vibration.

### BRIEF DESCRIPTION OF THE DRAWINGS

In order that the various embodiments of invention may be more readily understood, reference will now be made, by way of example, to the accompanying drawings in which:

FIG. 1 shows a schematic diagram of a material recovery system according to an embodiment of the invention;

FIG. 2 shows a schematic diagram of a material recovery system according to an alternative embodiment of the invention;

FIG. 3 is a perspective view of a screening apparatus used in the material recovery system in FIG. 1;

FIGS. 4 and 5 are cross section views taken longitudinally through the screening apparatus of FIG. 3;

FIG. 6 is a screen support frame in isolation of the screening apparatus in FIGS. 3 to 5;

FIG. 7 is a view like that in FIG. 6 but which shows the vibration motor removed from the screen support frame;

FIG. 8 is a further view of the screen support frame, but removed from its chassis;

FIGS. 9 to 12 are views that illustrate a tilt function of the screening apparatus;

FIGS. 13 to 15 illustrate a tensioning mechanism of the screening apparatus; and

FIGS. 16a and 16b include views of the screening apparatus which illustrate a multi-layered screening mesh.

### DETAILED DESCRIPTION

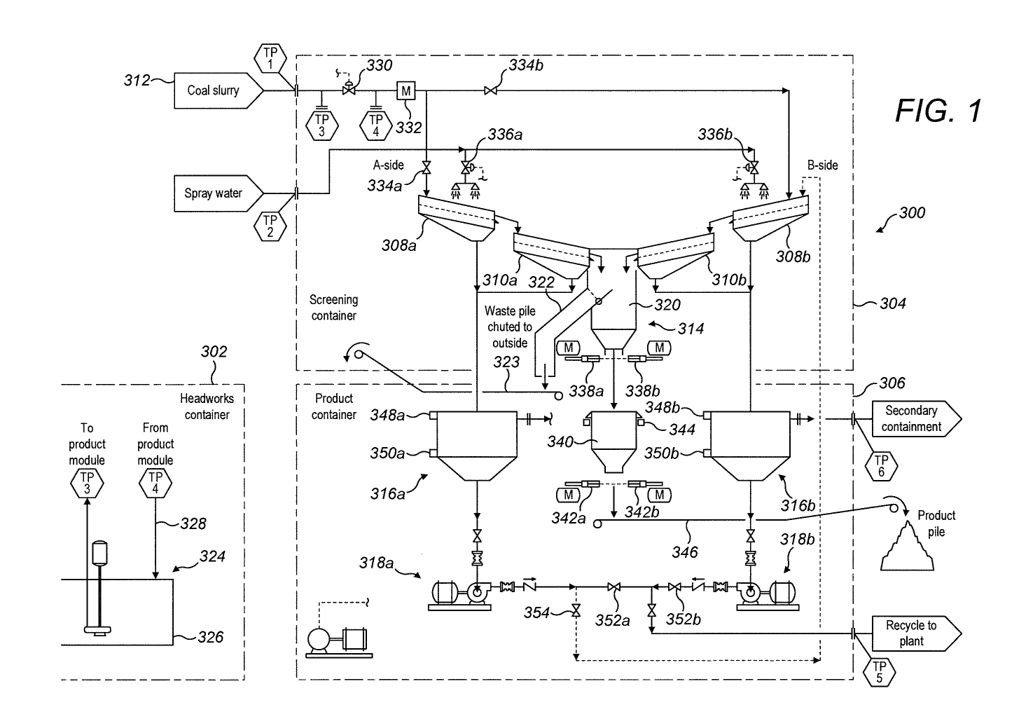

FIG. 1 shows schematically a material recovery process/system 300 that is designed to receive a material in-feed at a predetermined flow rate which is then processed and discharged at a product output point. The material in-feed may be in a dry form, for example powder, granular and aggregate materials to a wet slurry form from a suitable mining operation. It is particularly useful in a coal mining setting and, in this context the in-feed may comprise a washed coal flow stream from an operating coal preparation plant. Alternatively the in-feed may be recovered pond dippings or dredging from mobile equipment on the site of a coal waste impoundment. When used in these circumstances, an objective of the system is to reduce ash content and increase thermal values by removing higher ash size fractions through wet screening processes. Water content is reduced for final products through a similar de-watering screening process.

Still alternatively, the in-feed may be sourced from a reservoir of used drilling fluid having rock inclusions dispersed throughout the fluid. When used in this context, an objective of the system is to remove cuttings and rock inclusions from the drilling fluid to a sufficient extent to enable reuse of the fluid, which has both economic and environmental benefits.

The material recovery system has a modular configuration such that all of the plant is housed within one or more suitable containers. Here, each container is a steel shipping container known as a 40 foot ‘Hi Cube’ container, although the container may alternatively be an open-frame made out of suitable metal frame members (i.e. square section tubular steel struts, braces, and beams) to minimize costs. A shipping container provides a known unit for transportation and placement on-site which also protects the structures inside it from the environment. However, where the environmental conditions permit, it may be preferable to house the necessary plant in an open frame having comparable dimensions to a standard shipping container. Alternatively, the frame could be smaller than a shipping container if the size of the plant is such that a smaller frame is acceptable. For example, the modular material recover system in the form of an open frame could be placed outside adjacent, and optionally coupled to, a coal wash plant, for example, or on the superstructure of a drilling rig. Such modularization enables the system to be installed at a particular site at high speed and with minimal capital investment costs. For example, the system may be installed on the bank of a slurry impoundment for direct access to the source material or, alternatively, the system may be installed at a suitable location on an off-shore drilling rig where it can be configured to receive a supply of used drilling mud. Still alternatively, the system could effectively be installed into any process where there is a need to separate fine particles at comparatively high volumetric flow rates. Conversely, modularization also enables the system to be uninstalled rapidly to enable clean up operations to get underway. Although the process as shown in FIG. 1 is configured to be containerized, it should be appreciated that the process could also be housed in a more permanent ‘bricks and mortar’ facility, or ‘bolted on’ to an existing facility.

The material recovery system 300 can be used in principle to screen a variety of granular substances that may be produced in a mining operation. In a coal mining context, the system is particularly adept at recovering saleable coal product from fines and ultra fines that are suspended in slurries in coal impoundments or ponds. It is within this context that the system will now be described in further detail.

As shown in FIG. 1 the containerized system 300 comprises equipment that is housed within three separable containers, ‘units’ or ‘modules’: a ‘headworks’ container 302, a ‘screening’ container 304 and a ‘product container’ 306. These containers will now be described in overview.

The screening container 304 is required for sizing and drying of coal in-feed material and includes two separate pairs of screening devices, each pair including an upper screening device 308a, 308b and a lower screening device 310a, 310b. The screening container 304 is the top container which stacks directly on top of the product container 306. In this way, material output from the screening container 304 may fall under gravity into the product container 306. Coal slurry, being a mixture of water and fine coal particles generally less than 1 mm (millimeter) in size is fed into the screening container unit at a constant and adjustable flow rate. The in-feed 312 may be prepared by the headworks container 302 or it may be a direct coal waste stream from the coal preparation plant, which would otherwise be directed to a pre-prepared slurry impoundment. It is envisaged that an in-feed rate of between about 300 and 600 gallons per minute (GPM) is achievable with this system.

The upper screening devices 308a, 308b in each screening device pair are vibrating screens used for sizing separation and are equipped with a fine cloth working surface and water sprays to aid in wet sizing operations. The working cloth may be any suitable screening material such as a metallic (e.g. aluminum, brass, steel, etc.) or polymeric screen having appropriate dimensions and mesh size.

The sized overflow material from the upper screening devices then falls onto dedicated lower vibrating screens 310a, 310b which dry the material on a similar sized screen cloth. The dried overflow material falls from the lower screening devices into a chute system 314 for batch weighing or product disposal, as will be described.

The screening machines are vibratable screens that apply a broad spectrum of frequencies to a sieving screen to implement multi-frequency particle separation. A suitable machine is disclosed in U.S. Pat. No. 8,485,364 (B2) and also U.S. Pat. No. 6,845,868 (B1) for example, the contents of which are incorporated herein by reference.

The product container 306 receives underflows from both sets of sizing and drying screening devices in the screening container 304 while collecting overflow products from the drying screening devices separately for combined product loadout or simultaneous waste and product loadout. A dedicated underflow tank and pump 316a, 318a; 316b, 318b is used for each pair of screening devices. The pumps 318a, 318b monitor level sensors/controls in their tanks for automatic on and off operation as needed. In this way, the product container 306 collects processed material and discharges once a sufficient level is achieved, thereby by acting as a buffer for the system. The product container 306 may therefore be thought of as a buffer module for the system 300. The overflow from the first screening device shall either be discharged to waste or sent to the second set of screens for further processing. In this embodiment, the overflow from the second set of screens is discharged to waste.

A diverter waste gate 320 and chute 322 can receive the dried overflow from the first set of screening devices for separate dry disposal by preventing it from being batch weighed in a weigh hopper 340 and discharged onto a product belt 346—see functionality discussed below at heading “Operation for Double Sizing, Reduced Flow”. The dried overflow is directed onto a waste belt 323 which delivers the waste to an external collection point.

The headworks container 302 functions to regulate the in-feed flow rate, and so may be thought of as a regulator module for the system 300. In this sense, the headworks container 302 is an optional module that may be used when material is being recovered from a slurry body such as a pond or impoundment where it is necessary to regulate the flow of the recovered material through a surge tank while ensuring that adequate water contents are maintained for pumping purposes. The headworks container 302 receives semi-processed recovered coal, scalps off, and disposes of any larger oversized material that the screening container 304 cannot process using scalping screen device 324. Underflow from the scalping screen device 324 is collected in a feed tank 326 where it is pumped up to the screening container 304. A recirculation line 328 is included to keep the tank agitated to ensure material does not settle in case of production stoppage. The recirculation line is output from the in-feed line just downstream of a control valve 330 and upstream of a flow meter 332.

The functionality of the headworks container 302, the screening container 304, and the product container 306 have been described above in overview. The material recovery process will now be described in more detail with continued reference to FIG. 1.

Separation of Product from in-Feed Material

Coal slurry may be fed into the screening container 304 at rates of between about 300 to 600 gallons per minute. This in-feed stream is received at TP-1 (Tie-Point 1) if supplied from a nearby coal preparation plant or at TP-3 when supplied from the headworks container 302.

Downstream of these tie-points TP-1 and TP-2, the control valve, 330, automatically regulates the in-feed flow based on the flow rate measured by the flow meter 332, which in this embodiment is an electromagnetic flow meter. The flow meter 332 is located downstream in the same line. If a fault occurs within the screening container 304 or the product container 306, the flow meter 332 will automatically close to stop the flow of slurry. There is no provision for bypass or recirculation when the coal slurry is being fed from a preparation plant. When fed by the headworks container 302 at TP-1, the slurry can be re-circulated back into the feed tank 326 if a fault has occurred in the screening container or the product container.

The pair of screening devices provides the capability to process incoming slurry material at a rate in a portable solution as they are housed within a standard-size shipping container. To achieve separation of an incoming slurry into a single predetermined particle size both pairs of screening devices can operate in parallel to produce a maximum processing rate of 16 tons per hour at a slurry feed rate of 600 gallons per minute.

Downstream of the flow meter 332, the slurry flow splits into two circuits: ‘A-side’ and ‘B-side’. These circuits operate in parallel by opening valves 334a and 334a. These valves may be adjusted if necessary, either automatically or manually, to achieve equal flow to each circuit.

To optimize separating efficiency, each screening device in both A-side and B-side circuits is also sprayed with liquid, preferably water at a rate of approximately 150 gallons per minute that is sprayed evenly across and along the working surface of the screening cloth to provide efficient screening. Therefore, process water from plant utilities (or pumping skid from pond) should provide a total of approximately 300 gpm to a water input point of the screening container indicated as tie-point 2 or ‘TP-2’. Air operated block valves, 336a and 336b permit water flow to A and B circuits individually and the flow rates are controllable.

Underflow from the wet screening devices 308a, 308b and the drying screening devices 310a, 310b will drain through the bottom of the screening container 304 into tanks 316a and 316b, respectively, which are housed in the product container 306.

Dedicated effluent pumps 318a and 318b discharge into a common header tank (not shown) at outlet TP-5 which is the tie-point for the waste flow back to the preparation plant or return back to the a slurry pond via suitable hosing.

Weighing of Product

At the discharge of the lower screening device 310a of the first pair, there is the waste flop gate 320. The flop gate 320 will normally be closed to allow coal from both A and B circuits to fall into one common chute 322. The bottom of this chute 322 is equipped with two slide gates, 338a and 338b. These gates are normally open and allow coal to accumulate below in weigh hopper 340. Coal is held in the weigh hopper by a lower set of slide gates, 342a and 342a which are normally closed. After a predetermined period of time, currently envisaged to be about 3 minutes although it should be appreciated that this will be variable depending on the amount of product to be weighed, the upper slide gates 338a and 338b will close and stop flow of coal into the weigh hopper. Load cells equipped with a digital recorder 344 will record the batch weight and time of the reading. Once the reading has been taken, slide gates 342a and 342b will open, allowing coal to feed onto a product belt unit 346. The product belt unit 346 is currently envisaged to be a portable 24 inch wide belt conveyor being about 50 feet in length with a capacity of 120 TPH (tons metric per hour). This will permit a one ton batch of coal to be discharged in 30 seconds. It should be appreciated that these details are given here by way of example and are not intended to be limiting—exact specifications for product belt 346 will be specific to a given installation.

Once the weigh hopper 340 has been emptied, the scale will recalibrate to zero and slide gates 342a and 342b will close. This sequence will be interlocked to allow the upper slide gates, 338a and 338b to re-open, allowing the next batch of coal to accumulate into the weigh hopper. Some coal will accumulate on top of the gates 338a and 338b since the screens run continuously.

Tank Level Sensing and Control

Tanks 316a and 316b are large in volume and it is currently preferred that each has approximately 2300 gallons of capacity. With incoming flow of 450 gpm per tank, each tank has 5 minutes of capacity. The tanks are equipped with a high level switch, 348a and 348b which are interlocked to the influent slurry flow. When a high level is reached, the flow meter 332 will automatically close along with process water valves 336a and 336b. Once the high level alarm clears, these flow valves 336a, 336b may be reopened after a 2-minute delay.

Each tank 316a, 316b is also equipped with a low level switch 350a, 350b. When a low tank level is detected, low level switch 350a or 350b shall be interlocked to shut off to avoid damage to its corresponding pump 318a, 318b. After the low level alarm clears, the pump may restart after a 1-minute delay.

Balancing influent and effluent flow is an important factor to avoid excessive stops and re-starts of both pumps and valves. An operator should manually adjust the opening of pump discharge valves 352a, 352b to a position which maintains a reasonably consistent tank level. Alternatively, an automatic control system may perform this process.

In embodiments where the valve work is manually controlled, if the influent slurry is at the designed flow rate and the tank levels reaches high level consistently, the corresponding pump discharge valve may be opened slightly. If the tank levels tend to reach low levels consistently, these hand valves should be closed slightly.

Operation for Double Sizing, Reduced Flow

When a low ash middlings product must be captured, the A-side and B-side circuits are operated in series and produce a maximum product rate of 8 tons per hour at a slurry feed rate of 300 gpm. To operate in series, the hand valve 334b located in the screening container and which regulates the in-feed, must be closed such that all slurry initially flows to the A-side. In addition, the flop gate 320 must be opened to physically separate the dry product discharging from screening devices 310a and 310b.

Overflow from screening device 308a will be the high ash oversize product that is discarded through the chute 322. This material may be held in a container and disposed of periodically or, as is shown in FIG. 1, the material is fed onto a portable conveyor. The final equipment configuration will depend on project specific requirements.

Underflow from screening device 308a will accumulate in tank 316a. Effluent from its pump 318a will be routed to screening device 308b. Thus, screening device 308b operates in series with, and downstream of, screening device 308a. To accomplish this, hand valve 352a located in between the two pumps must be closed and hand valve 354 must be opened to allow fluid material to flow from the pump 318a along the by-pass line (shown here as dotted) to the input of the screening device 308b.

Overflow from the B circuit that is captured in the hopper 340 is recovered clean coal product. Both solids and liquids flow through the B-side will be similar, but decreased flow rates, to the parallel operation. Interlocks for both high and low tank level are controlled in the same manner for both circuits.

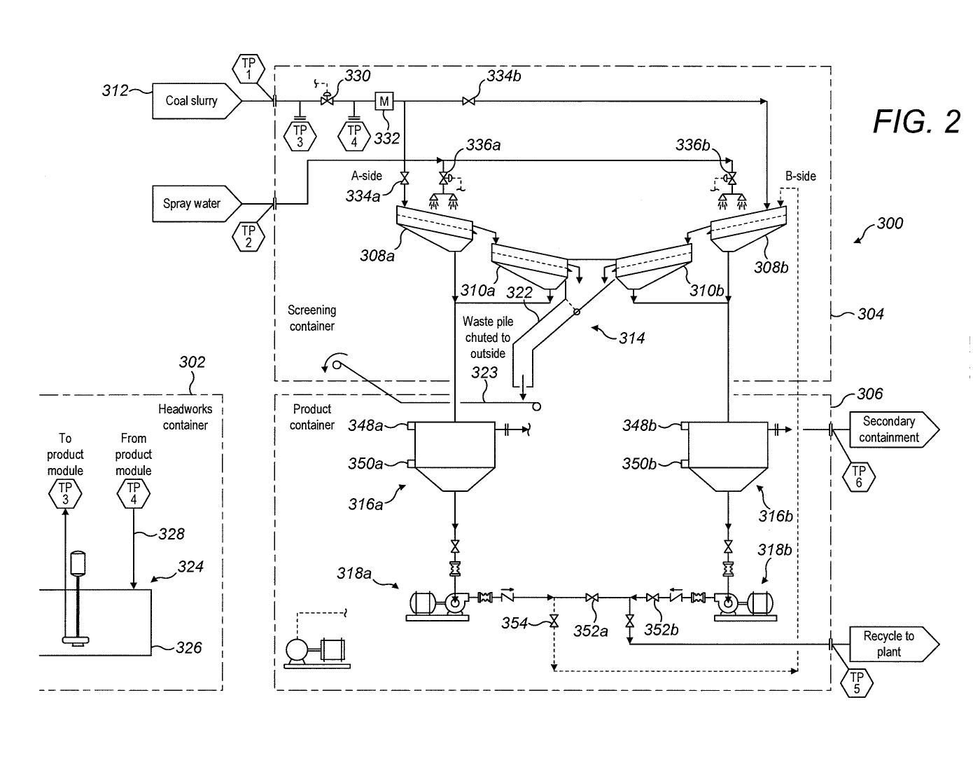

An alternative embodiment of the containerized system is shown in FIG. 2. This embodiment is optimized for processing fluid to remove small particles, for example removing cuttings from used drilling fluid. It is in this context that FIG. 2 shall be described, as it provides the clear benefit of minimizing waste of drilling fluid by stripping the fluid away from the cuttings before the cuttings are disposed. In particular, in this embodiment the system is able to screen the drilling fluid of very fine cuttings to a level that is not possible with prior art systems.

The second embodiment is simpler than the first, as there is no separation of a target particle size involved when processing drilling fluid; the aim is simply to remove all cutting material, and to return drilling fluid that is suitable for reuse. Therefore, the components involved in recovering and collecting particles of a target size can be dispensed with in this embodiment, as all overflow from the screening assemblies 308a, 308b, 310a, 310b is treated as waste. In particular, the embodiment shown in FIG. 2 dispenses with the following components of the FIG. 1 embodiment: the chute system 314 including the waste gate 320 and the chute 322; the weigh hopper 340; the upper and lower sets of sliding gates 338a, 338b, 342a, 342b; and the product belt unit 346.

All of the remaining components of the embodiment shown in FIG. 2 are identical to their counterparts shown in FIG. 1, and operate in the same manner.

Accordingly, in this embodiment the system 300 takes an in-feed from a tank of used drilling fluid or in-line from the drilling rig, which enters the screening container 304 at the in-feed point 312, either directly from the tank or through the headworks container 302, which as in the previous embodiment is operable to regulate the flow of fluid into the screening container 304.

The fluid then passes through the screening assemblies 308a, 308b, 310a, 310b which process the fluid in the same manner as in the previous embodiment. In particular, processed fluid is optionally fed back to the B-side screening assemblies 308b, 310b for further processing, for enhanced performance.

Overflow from the screening assemblies 308a, 308b, 310a, 310b comprising cuttings removed from the fluid is directed into the chute system 314, which in this embodiment is simply a chute that delivers the overflow to the waste belt 323, to be discharged to an external collection point.

Underflow from the screening assemblies 308a, 308b, 310a, 310b consists of processed drilling fluid with most or all of the cuttings removed, which is therefore suitable for re-use. As in the previous embodiment, the processed fluid is collected in the tanks 316a, 316b, until the respective high level sensors 348a, 348b indicate that a maximum level has been reached. At this point the fluid is pumped by the respective effluent pumps 318a, 318b to an outlet to return the fluid to the plant. For example, the outlet may feed into an external tank for holding recycled drilling fluid prior to reuse.

Technical Advantages

There are several reasons why the multi-frequency vibratory system is able to screen fine sizes that other screening technologies are not able to, including:
the multi-frequency vibratory system avoids blocking or blinding at fine levels as seen in other solutions;
the screen area required to achieve an acceptable, commercially viable throughput is materially different with the multi-frequency vibratory system;
the multi-frequency vibratory system has the ability to break the bonds between the fine particles due to the high level of energy on the screen surface;
the multi-frequency vibratory system has the ability to wash the material with water jets to “wash away the finest particles” (normally rock) on ultra fine screens;
the low tension required in the screen for the multi-frequency vibratory system allows the screen to be made from a range of different materials (nylon, polyester etc.) and also to be less susceptible to tearing from tension;
the containerized solution can be mobile, and requires a small footprint and low energy input compared with other solutions;
the multi-frequency vibratory system has the ability to “dry” the product to an acceptable level without using heat.

The inventors believe that no existing system is able to receive a pumped slurry (containing a target fine particle size range) input at one end, pump it over a screening machine, spray it with water, screen it with an combination of tensioned and un-tensioned meshes (layered) made of a variety of different materials, separate at an efficiency of 95% and above, convey the screened product by gravity to a second screen, screen it with another combination of different meshes (also layered) and then convey out the other end as usable, saleable product, whilst the remaining slurry is then pumped back out of the solution.

Similarly, the inventors believe that no existing system is able to receive a pumped drilling mud/fluid in put at one end, screen that fluid over a combination of tensioned and untensioned meshes whilst separating at an efficiency of 95% and above, optionally screening the drilling fluid a second time over a second screen, and to convey the cleaned drilling mud to a suitable storage tank or in-line to a drilling rig for reuse.

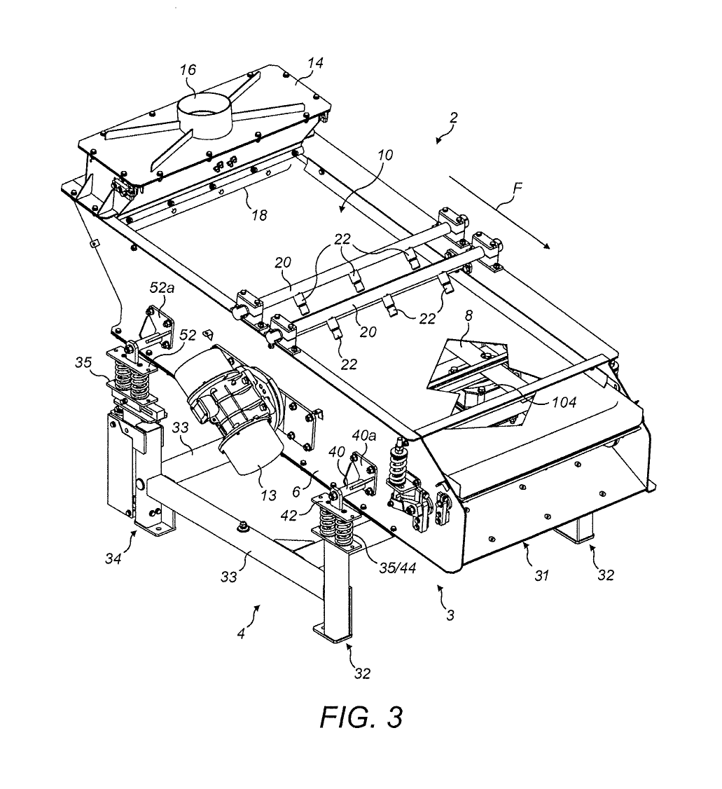

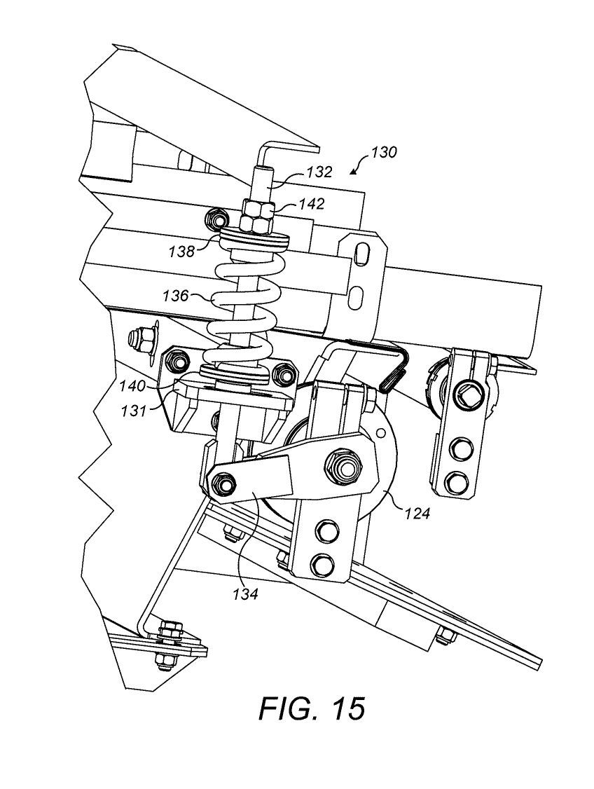

As has been mentioned, a screening machine suitable for use in the above process is described in U.S. Pat. No. 8,485,364 (B2) and also U.S. Pat. No. 6,845,868 (B1) for example. A suitable screening apparatus is also shown in FIGS. 3 to 16a/b, and will now be described below.

Referring firstly to FIGS. 3 to 5, screening apparatus 2 includes a screening deck 3 that is supported on a frame-like base 4 that supports the screening deck 3 at front and rear locations.

The base 4 is adjustable, as will be described later, to enable the inclination of the screening deck to be adjusted and thereby to control the speed at which a material is processed by the screening apparatus 2.

In overview, the screening deck 3 comprises a housing/body 6 including first and second parallel side walls 6a, 6b between which is mounted a vibration mechanism 8, and a screen assembly 10 including a support screen 11 and a working screen 12.

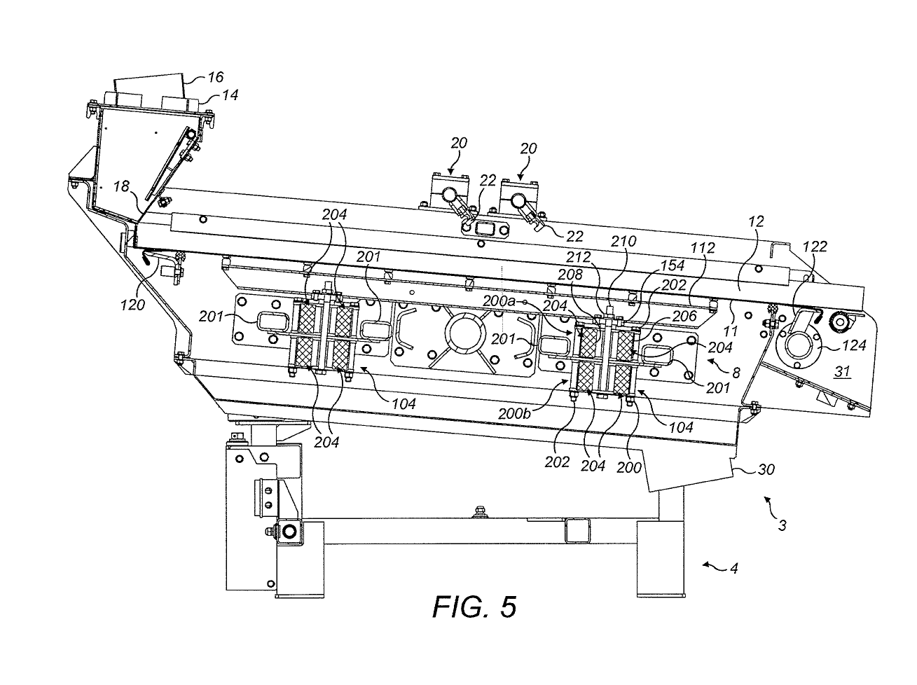

Two vibration motors 13 are mounted to the body 6—only one of these vibration motors is shown in FIG. 2, but both of them are shown in FIG. 5. A loading hopper 14 is mounted onto the upper side of the body 6 at an ‘upstream’ end, at the far end of the body 6 in FIG. 2. The loading hopper 14 has a circular material inlet 16 to admit a flow of material into the hopper 14 and an elongated material outlet 18 to discharge material across the width of the screen assembly 10.

A pair of spray nozzle assemblies 20 are mounted approximately mid-way along the body 6. Each spray assembly 20 includes a plurality of nozzles 22, three in the specific embodiment shown in the figures. The nozzles 22 are directed towards the screen assembly 10 at an angle and are configured to spray fluid, preferably water, onto the material flowing on the screen underneath the nozzles 22.

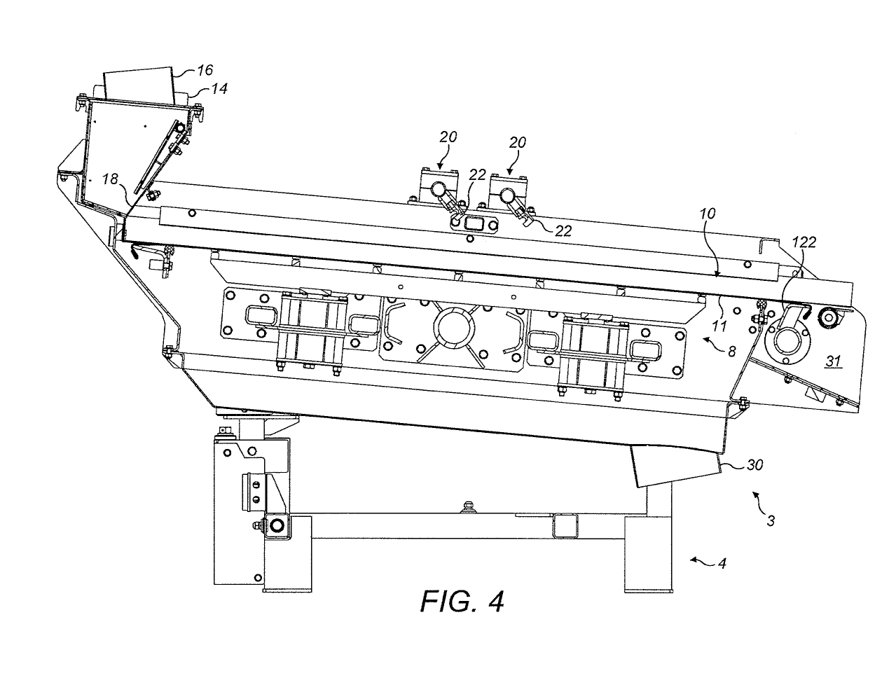

In use, the vibration motors 13 excite the body with a single frequency of vibration which is transmitted to the vibration mechanism 8 and the support screen 11, as will be described. The vibration of the screen assembly 10 causes material that is discharged onto the screen by the loading hopper to be conveyed along the screen in the direction of the arrow ‘F’. Undersize particles of the material will pass through the screens and will exit the apparatus via an underflow outlet 30 (see FIG. 4) and oversize particles will travel along the top of the screen and exit the apparatus at the overflow outlet 31, at the open downstream end of the body 6.

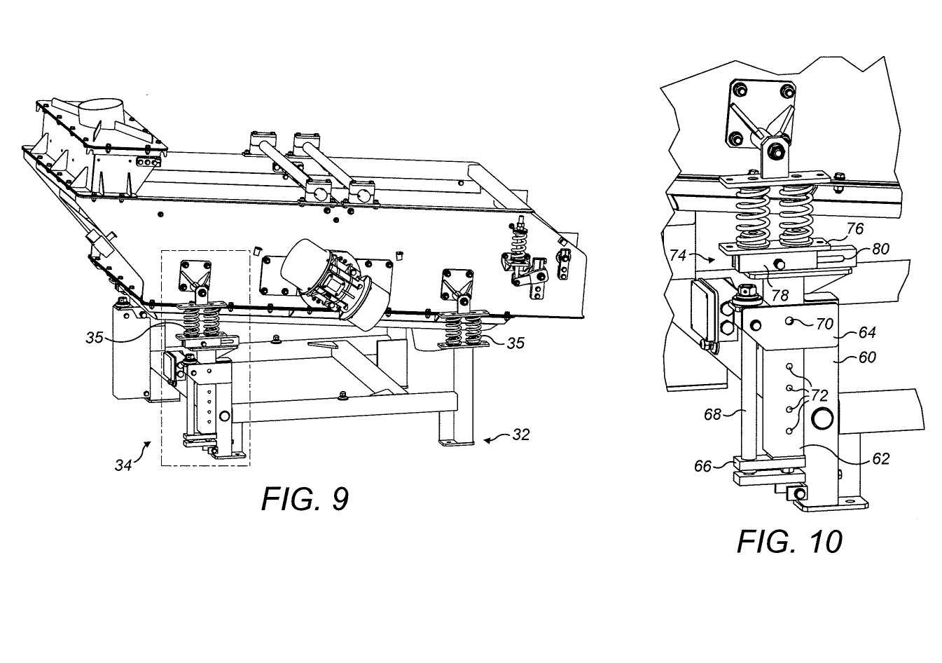

As has been mentioned, the apparatus 2 can be inclined at a selected angle which influences the speed at which the material passes along the screens. The base 4 permits the angle of the screening deck 3 to be varied, as will now be explained with reference also to FIGS. 9 to 12.

The base 4 includes a pair of front legs 32 and a pair of rear legs 34 on which the screening deck 3 is mounted. The legs are braced by a set of lateral bars 33 to give the base 4 strength. Each of the pairs of legs 32, 34 includes a sprung suspension arrangement 35 that allows the screening deck to vibrate freely relative to the base 4. Furthermore, the rear legs 34 are configured to enable the height of the rear of the screening deck 3 to be raised or lowered.

In more detail, each side of the forward portion of the body 6 includes a stub axle 40 that is mounted by a mounting bracket 40a to a side wall of the body 6. The stub axles 40 terminate in a horizontally-oriented spring plate 42 which rests on a set of springs 44 mounted on the tops of the front legs 32. In a similar manner, a stub axle 50 is mounted by a mounting bracket 52a to respective side walls of a rear portion of the body 6. The stub axles 50 terminate in a spring plate 52 which rests on a second set of springs 54 mounted on the tops of the rear legs 34.

The height adjustment mechanism of the rear legs 34 is illustrated in FIGS. 9 to 12. Note than an outer cover of the rear leg 34 has been omitted so that the components of the leg 34 can be seen more clearly. Each of the rear legs 34 are the same so only one of the legs will be described here for clarity. The leg 34 is a compound structure including multiple components to enable the height of the rear end of the screening deck 3 to be adjusted. In overview, however, the leg 34 comprises a static stanchion 60 which supports a parallel sliding member 62 that can slide up and down with respect to the stanchion 60. The stub axle 50 is mounted to an upper end of the sliding member 62 by which means the screening deck is height adjustable.

In more detail, the sliding member 62 is slidably received through a guide bracket 64 that is mounted to an upper end of the stanchion 60, such that the sliding member 62 is guided for parallel movement to the stanchion 60. The lower end of the sliding member 62 includes a guide arm 66 that slidably engages with a guide rod 68 that depends downwardly from the outer end of the guide bracket 64. The guide arm 66 therefore slides relative to the guide rod 68 and so constrains the lower end of the sliding member 62 for parallel sliding movement with the stanchion 60. Note that the lower end of the guide rod 68 is braced against the lower end of the stanchion 60 so as to lie parallel with it.

Means may be provided to lock the sliding member 62 at a selected displacement relative to the stanchion 60. For example, although not shown here, a fastener may be received through an aperture 70 provided in the guide bracket 64 for engagement with one of a set of height setting apertures 72 defined by the sliding member 62 so that it may be locked into a selected position.

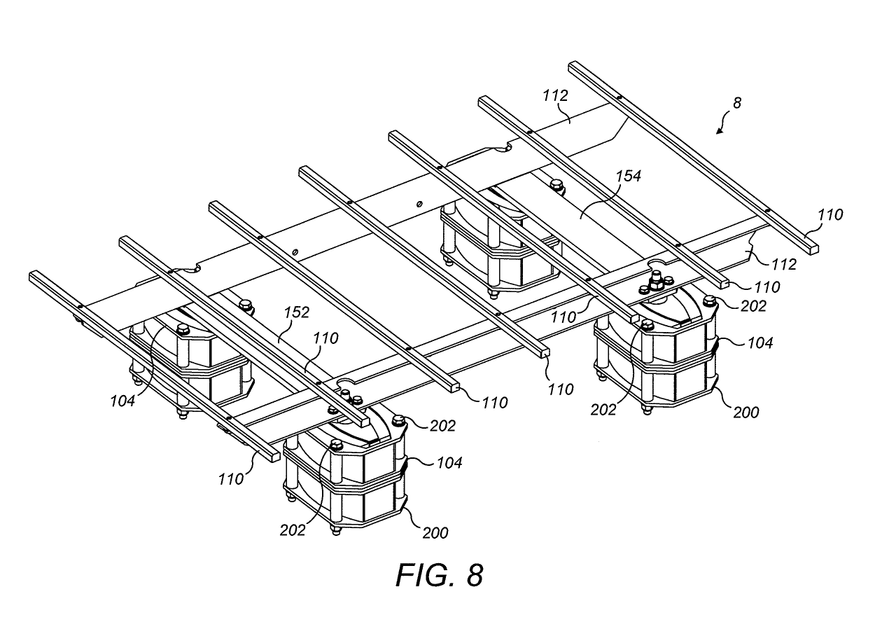

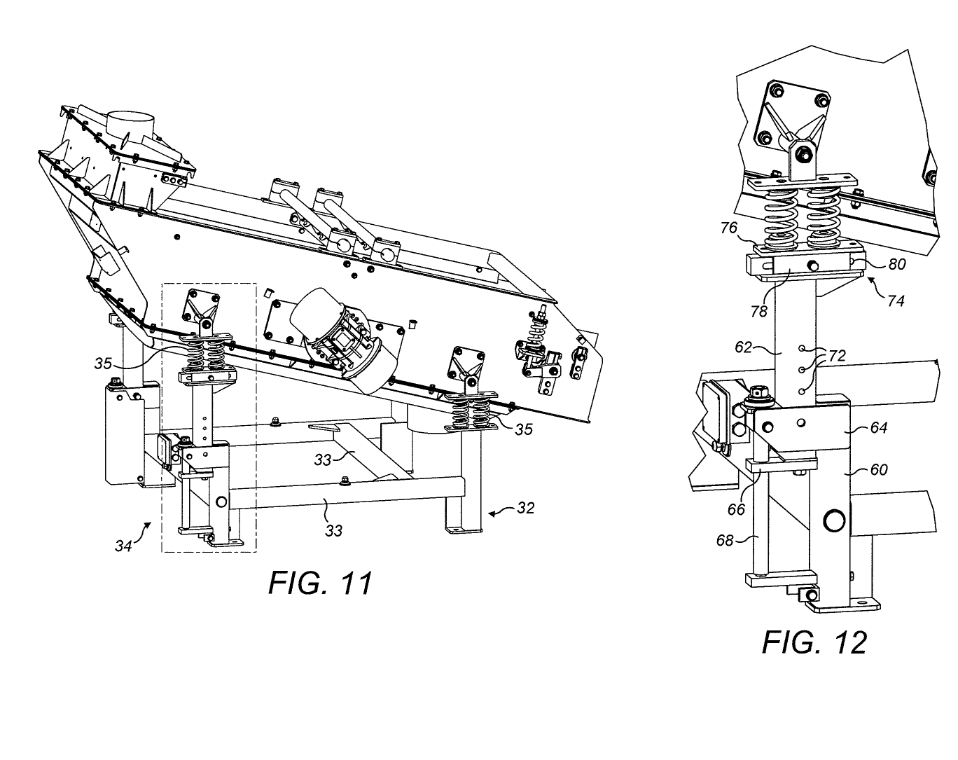

In order to compensate for the horizontal shift in position of the stub axle 50 as the rear end of the screening deck 3 is tilted, the set of springs are mounted on a slider mechanism 74 carried by the top of the sliding member 62. The slider mechanism 74 includes a lower spring plate 76 mounted on a carriage 78 that is slidable in a slotted bar 80 fixed to the top of the sliding member 62. The difference in position of the slider mechanism 74 at relatively ‘flat’ and ‘tilted’ positions of the deck, respectively, can be seen by comparing FIGS. 8 and 11.

Having explained the height adjustability of the screening deck, discussion will now turn to the vibratory separating mechanism of the screening deck, with reference to FIGS. 3 to 8, and FIGS. 13 to 16a/b.

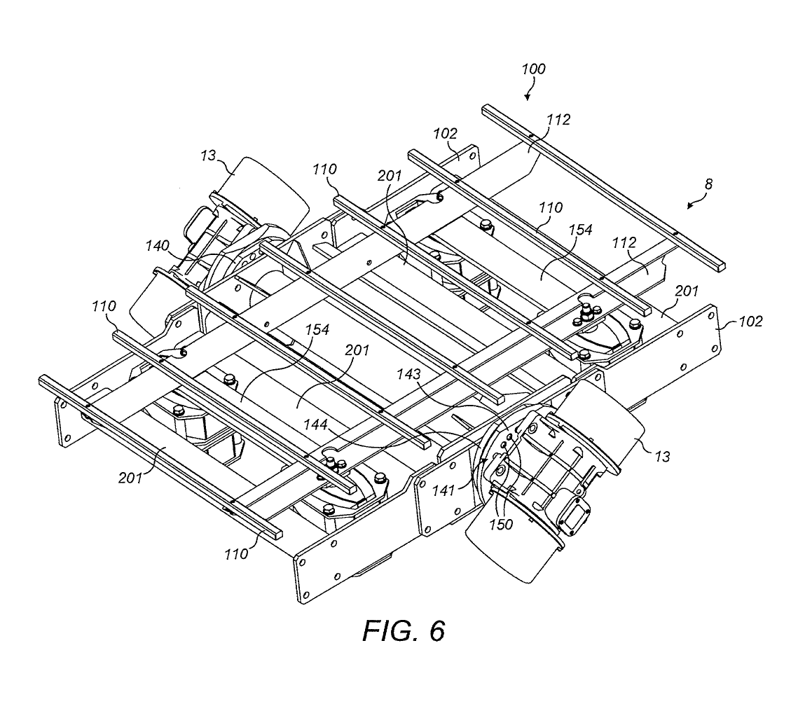

As has been explained, the body 6 houses a vibration mechanism 8, and this is shown in isolation from the body in FIGS. 6, 7 and 8.

In overview the vibration mechanism 8 comprises a frame 100 that is mounted between side rails 102, and a set of multifrequency vibration adapters 104 mounted to the frame 100. The multifrequency vibration adapters 104 are excited by the single-frequency vibration energy provided by the vibration motors 13 and generate impulse forces to the frame 100 in the manner described in U.S. Pat. No. 8,485,364 (B2) and also U.S. Pat. No. 6,845,868 (B1).

The vibration mechanism 8 acts an interface to transfer impulse forces generated by the multifrequency vibration adapters 104 to the screen assembly 10 (not shown in FIGS. 5 to 7) in a manner which ‘beats’ the screen assembly with a continuous series of pulses with an irregular period. Vibration mechanism 8 therefore provides pulses to the assembly at multiple frequencies and amplitudes. The frame-like structure of the mechanism can therefore be considered to be a ‘beater grate’ and will be referred to as such from now on. The frame 100 of the beater grate 8 includes a plurality of interface members 110 in the form of cross members that are mounted on first and second longitudinal members 112 that are spaced from one another and in parallel. The multifrequency vibration adapters 104 are connected to the underside of and thus depend from the longitudinal members 112. In this specific embodiment, two adapters 104 are connected to each of the longitudinal members 112, and the longitudinal members 112 support seven interface members 110.

The beater grate 8 is shown in situ in the longitudinal section views of FIGS. 4 and 5, which show a mesh or support screen 11 in contact with the interface members 110. The function of the support screen 11 is to absorb the impulse forces generated by the adapters 104 and transmitted to it via the interface members 110 and so it is preferred that the support screen 11 is a relatively rigid mesh, for example a steel or aluminum mesh. Furthermore, since the support screen supports a working screen 12 having a finer mesh size, it is preferred that the support screen 11 has a coarse mesh size to allow the particles that pass through the relatively fine mesh of the working screen 12 to also pass through the coarse support screen 11.

The support screen 11 supports a working screen 12 on its surface. The working screen 12 is preferably finer than the support screen and may be configured to screen particles under 50 microns in size. For example, the screening apparatus used in the process of FIG. 1 preferably have a mesh size of ‘230 mesh’ which corresponds to an aperture size of approximately 63 microns, but it should be appreciated that this may be lower. It is envisaged that an aperture size range of about 40 to 150 microns would be suitable. The screens may be metallic, for example a fine steel mesh, or alternatively may be non-metallic for example nylon or polyester mesh. By virtue of the high vibration forces generated by the beater grate 8, the screening deck 3 is able to screen materials of a fine particle size without clogging of the mesh. The support screen 11 is preferably significantly coarser than the working screen 12 and, therefore, it is envisaged that mesh apertures of between 1 and 5 mm are suitable, by way of example.

Very fine working meshes have very small apertures and the diameters of the mesh elements are extremely fine, which results in a large open area. A downside of such fine meshes is that the large open areas and fine mesh elements reduce the strength of the meshes to an extent that the relatively coarse support screen 11 may damage the working screen 12. To improve the durability of the working screen 12 in such circumstances, an intermediate mesh/screen 17 may be used between the support screen 11 and the working screen 12. Preferably the intermediate mesh has an aperture size in the region of 0.5 mm to 2 mm.

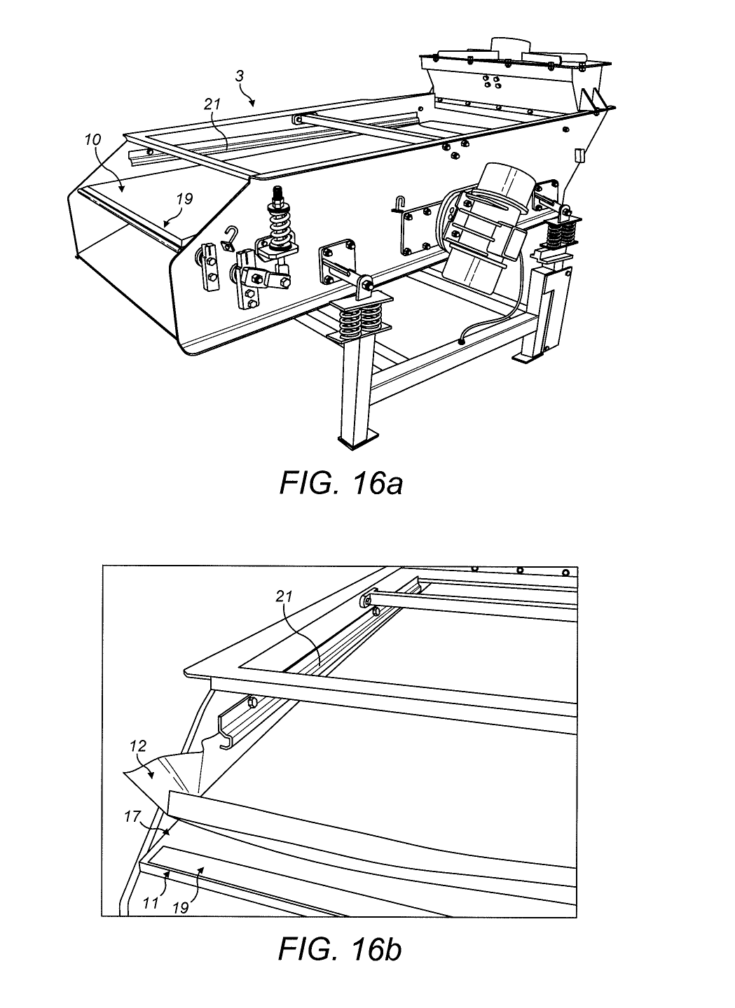

Such a configuration is shown in FIGS. 16a/b. Here, the mesh/working screen 12 can be seen atop the support screen 11. The intermediate screen 17, which is optional and the need for which depends on the required mesh size of the working screen 12, is sandwiched between the working screen 12 and the support screen 11. It has been mentioned that the support screen 11 is held under high tension. However the working screen 12 and the intermediate screen 17, if used, are held under little or no tension. This greatly increases the durability of the screens which enables such fine mesh screens to be used in combination with a highly-tensioned support screen 11 to separate very fine particles effectively without clogging or suffering damage.

To enable rapid replacement of the intermediate screen 17 and the working screen 12, the screens are secured to the support screen 11 along their long edges by a temporary fixing arrangement 19. In this embodiment, the temporary fixing arrangement 19 is in the form of a hook and loop fastening strip arranged along the short edges of the working screen 12 and the intermediate screen 17. Note that only the front fixing arrangement is shown here, although a similar fixing arrangement is also provided along the rear short edge of each screen.

Holding clamps 21 are arranged on the interior surface of the side panels of the body which are able to press the long edge of the mesh against the side walls by way of a rubber profile provided on the clamp. This holds the long edges of the mesh but does not place it under any significant tension.

Turning to FIGS. 4 and 5 particularly, which illustrate the tensioning mechanism for the support screen 11, the upstream end of the support screen 11 is held in position by a first blade 120 that extends across the width direction of the support screen 11. As shown here, the upstream end of the support screen 11 is folded around the first blade 120 and is held in position by virtue of the rigidity of the screen 11. The grip of the first blade 120 on the screen 11 can be enhanced if necessary by bonding or fastening the screen 11 to the blade 120. The downstream end of the support screen 11 is held in position by a second blade 122 that also extends across the width direction of the screen 11. In a similar manner to the upstream end of the screen 11, the downstream end of the screen 11 is folded around the second blade 122 and is held in place by virtue of its rigidity, although it may be bonded or fastened to the second blade 122 if desired for extra strength.

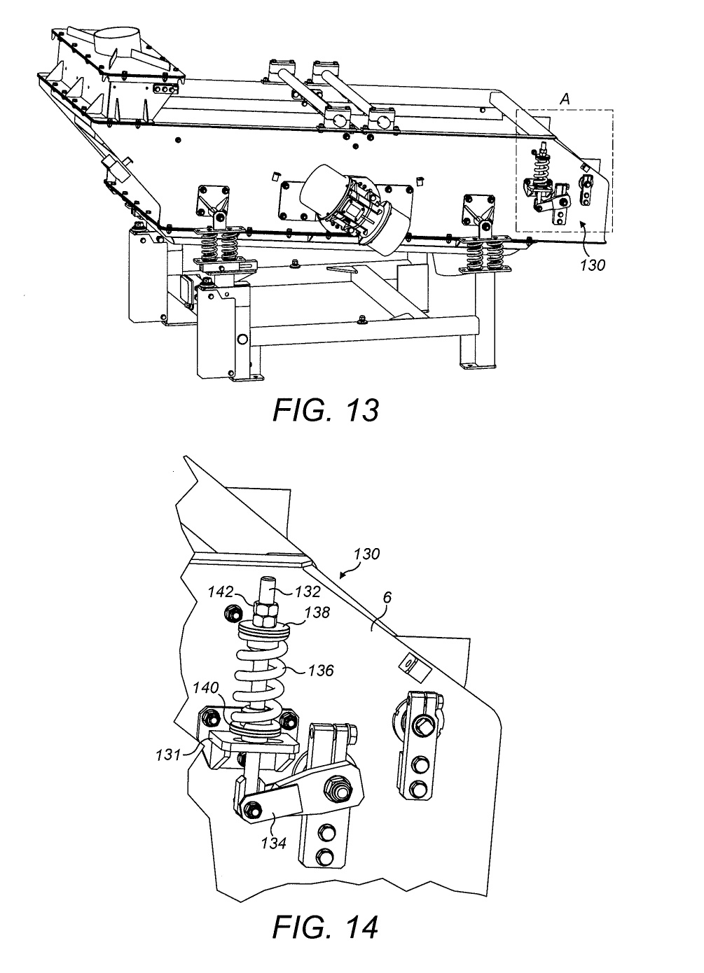

The second blade 122 is provided with the facility to tension the support screen 11 to a predetermined level and maintain that tension. As shown in FIGS. 4 and 5, the second blade 122 is mounted on a radially adjustable mounting 124, the radial position of which is determined by a tensioning mechanism 130 is shown perhaps most clearly in FIGS. 13, 14 and 15.

The tensioning mechanism 130 is mounted on the body 6 of the screening deck by a mounting bracket 131 and includes a spring-loaded push rod 132 that acts on the radially adjustable mounting 124 via a crank arm 134 to bias the mounting 124 in a clockwise direction to maintain tension on the second blade 122.

A spring 136 is captured between upper and lower spring caps 138,140 that are slidable on the push rod 132. The lower spring cap 140 bears against the mounting bracket 131 and the upper spring cap 138 is retained on the push rod 132 by a lock-bolt arrangement 142. The lock-bolt arrangement 142 is threaded onto an upper part of the push rod 132 and can be rotated to vary the linear position of the upper spring cap 138 on the rod, thereby varying the preload on the spring 136 and the tensioning force imparted to the second blade 122 in the force of a clockwise torque applied to the radial mounting 124.

Returning to the beater grate 8, it has been mentioned that the beater grate 8 is mounted between side rails 102, and the side rails 102 are in turn mounted to the body 6. More specifically, the vibration adapters 104, which are vibrationally coupled to the frame 100 via longitudinal members 112, are directly connected to the side rails 102, and therefore also to the body 6 of the screening deck 3, by way of lateral structures in the form of cross beams 201. In this way the single vibration frequency of the body 6/side rails 102 as generated by the motors 13 is transmitted to the vibration adapters 104, is amplified and transformed into multi frequency vibration of the beater grate 8. This will be explained in further detail later.

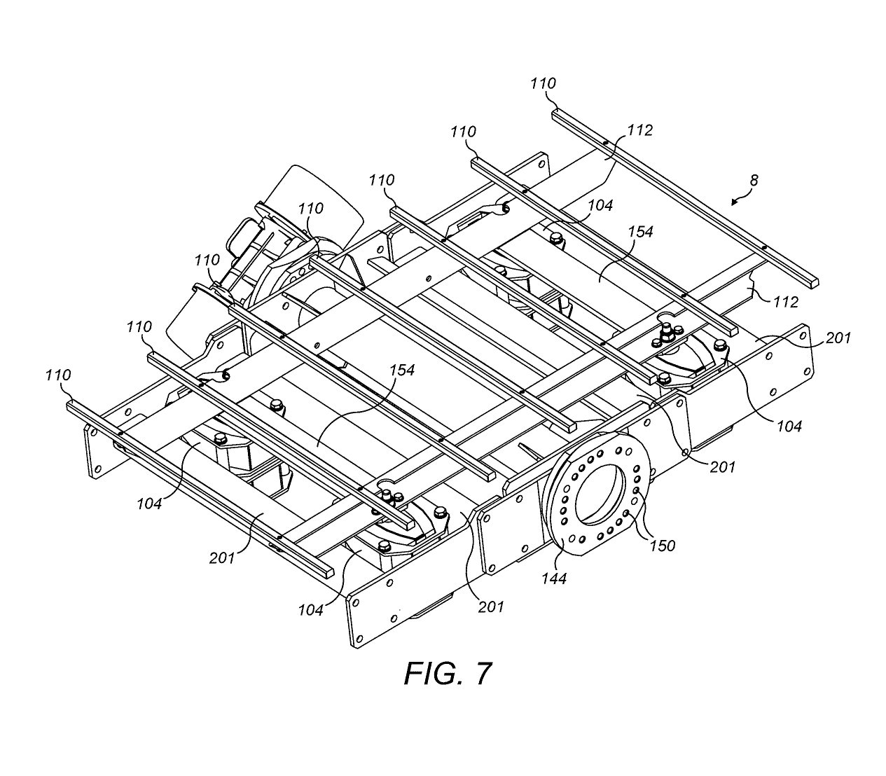

As shown clearly in FIG. 6 the vibration motors 13 are mounted on outer faces of the side rails 102 and are shown here as configured such that their longitudinal axes are inclined relative to the general plane of the vibration mechanism 8. More specifically, each motor includes a radially-positionable mounting 141 which enables the motors 13 to be mounted at a plurality of radial positions relative to the beater grate 8. The radially positionable mounting 141 comprises a first plate 143 associated with the motor 13 and a second plate 144 associated with the side rail 102—note that the second plate 144 is shown particularly well in FIG. 7.

Each of the first plate 143 and the second plate 144 defines a series of holes 150 (only some of which are labeled for clarity) defining a fixed pitch circle diameter. By aligning the holes 150 on the first plate 143 with the holes 150 of the second plate 144, the angular orientation of the vibration motors 13 may be selected. The benefit of this is to control the vibration direction of the screen 11 and particularly the proportional split between the vertical and horizontal components of vibration. The practical effect of this is to enable the travel speed of the material over the screen to be varied. For example, in order to dry a comparatively wet material, it may be desirable for the material to travel relatively slowly over the screen 11. Therefore, the motors 13 may be oriented so that they adopt a relatively shallow inclination with respect to the frame. A significant advantage of the selective angular orientation of the vibration motors 13 is that a forward progress of the material across the screen 11 can be maintained, even if the screening deck 3 is configured to have a negative inclination, which may be desirable in some operations.

FIG. 8 shows the mounting position of the multifrequency vibration adapters 104 in more detail with respect to the beater grate 8.

In the embodiment of FIG. 8, two adapters 104 are mounted to each of the longitudinal members 112 of the beater grate 8, respectively. One adapter 104 is mounted towards either end of the longitudinal member 112 so as to distribute the impulse forces generated by the adapters evenly into the longitudinal members 112 and thus into the interface members 110. Note that the beater grate 8 also includes first and second brace members 152, 154. The first brace member 152 is positioned to the left hand side of FIG. 8 and spans laterally the gap between the longitudinal members 112. The second brace member 154 is shown to the right of FIG. 8 and spans laterally the gap between the longitudinal members 112. A pair of the adapters 104 is mounted to each of the brace members 152, 154. The brace members 152,154 provide the beater grate 8 with increased stiffness to ensure that the vibrational frequencies generated by the adapters 104 are transferred to the support screen 11 by the interface members, and that the energy is not absorbed appreciably by flexing of the beater grate 8.

The adapters 104 are shown in more detail in the cross section view of the screening deck 3 in FIG. 5.

Each of the adapters 104 includes a housing 200 that contains and protects the inner components. In this embodiment, the housing 200 is in two parts, including upper and lower housing parts 200a, 200b that are secured together by a series (four in this example) of clamping bolts 202.

The internal components of the adapters 104 include vibrational masses 204 that are generally annular in form to define an outer annular face 206 and an inner annular face 208. The outer annular face 206 is connected the outer housing 200. The inner annular face is not connected to the outer housing 200 is connected to a vibration transmission member 210 that is bolt-like in form. The masses 204 may also be half-annular, and grouped into pairs so as to substantially surround the transmission member 210, as can be seen in FIG. 8. The vibration transmission member 210 extends upwardly from the top of the adapter and passes through an aperture in the longitudinal member 112. The upper end of the vibration transmission member 210 includes a retaining bolt 212 is therefore fastened securely to the longitudinal members 112.

Note that the vibrational masses 204 are resilient in that they are formed of a suitable polymeric material that allows the vibration transmission member 210 to move slightly with respect to the outer housing 200.

During use, the vibration of the body 6 by virtue of the vibration motors 13 is transmitted to the support screen 11 so that it vibrates with a single frequency of oscillation in a plane that is determined by the angle of inclination of the motors 13. The outer housings 200 of the adapters 104 are also connected to the body 6 by way of cross beams 201 and so are also exited with the single frequency of vibration generated by the motors 13. As each outer housing 200 vibrates, energy is transmitted into the masses 204 by virtue of the connection between the masses 204 and the respective housing 200. The vibrational energy is therefore transmitted to the vibration transmission member 210 which is caused to vibrate at a resonant frequency. Since the vibration transmission member 210 is connected to the longitudinal members 112, the beater grate 8 is also caused to vibrate/oscillate at a resonant frequency that is determined by the mass of the resilient, vibrational masses 204 and the combined mass of the beater grate. The interface members 110, the longitudinal members 112, the masses 204 and the vibration transmission members 210, and can therefore be considered together to be a single active mass that is driven to vibrate at multiple frequencies by the single frequency input as generated by the motors 13. The interface members 110 therefore strike the support screen 11 repeatedly and impart high energy impact forces to the screen 11 having a broad frequency spectrum, that is to say having an irregular striking period. Such impact forces having a multi frequency composition is an extremely effective technique to ensure that the support screen 11, the intermediate screen 17 and the working screen 12 do not become clogged. The vibrational masses 204 therefore are coupled between the body 6 and the working screen 12 and are operable to convert the single frequency oscillations of the body 6 to multifrequency oscillations of the beater grate 8. The beater grate 8 therefore becomes a single active mass that is actuated by the vibration adapters 104. Note that the vibration adapters 104 are passive devices that make use of the vibrational energy generated by the vibration motors and transmitted to the vibration adapters via the body 6.

It should be noted that although the above process described above with reference to FIG. 1 involves the use of two pairs of screening machines, this is not essential and instead the process may use only a single screening machine or more than two pairs of screening machines.

It will be appreciated by a person skilled in the art that the invention could be modified to take many alternative forms to that described herein, without departing from the scope of the appended claims.

What is claimed is:

1. A portable, self-contained screening module for processing a bulk material in-feed, the screening module comprising:
an inlet arranged to receive the material in-feed;
at least one screening assembly arranged to separate particles having a predetermined size classification from the material in-feed;
a material outlet arranged to discharge processed material; and
a waste outlet arranged to discharge the separated particles.

2. A screening module according to claim 1, wherein the or each screening assembly is arranged to apply multifrequency vibration to the material in-feed to separate particles.

3. A screening module according to claim 1, comprising two or more screening assemblies, each screening assembly being arranged to separate particles according to a respective size classification, each respective size classification being different to the others.

4. A screening module according to claim 3, wherein the screening assemblies are arranged in sequence.

5. A screening module according to claim 4, wherein the screening assemblies are arranged with reducing size classifications.

6. A screening module according to claim 3 comprising a product outlet, wherein the screening module is arranged to discharge particles of a target size from the product outlet.

7. A screening module according to claim 3, comprising two processing circuits arranged in one of parallel and series, each circuit having one or more respective screening assemblies.

8. A screening module according to claim 7, wherein each circuit is independently controllable.

9. A screening module according to claim 1, wherein the or each screening assembly comprises a working screen having a mesh that is sized to separate particles according to the predetermined size classification.

10. A screening module according to claim 9, wherein the working screen is supported on a support screen.

11. A screening module according to claim 1, comprising at least one nozzle arranged to spray liquid onto the screening assembly.

12. A screening module according to claim 1, wherein the screening module comprises a container in which the at least one screening assembly is arranged.

13. A screening module according to claim 12, wherein the container is a shipping container.

14. A screening module according to claim 12, wherein the container is an open frame.

15. A modular containerized bulk material recovery system for processing a material in-feed, the system comprising a screening module according to claim 1.

16. A system according to claim 15, further comprising a portable, self-contained buffer module comprising a buffer inlet arranged to connect to the material outlet of the screening module, storage means, and a buffer outlet; wherein the buffer module is arranged to direct processed material received at the buffer inlet to the storage means, and to discharge stored material to the buffer outlet on demand.

17. A system according to claim 16, wherein the buffer module comprises a container.

18. A system according to claim 17, wherein the container is a shipping container or an open frame.

19. A system according to claim 16, wherein the screening module is positioned on top of the buffer module.

20. A system according to claim 15, comprising a portable, self-contained regulator module positioned upstream of the screening module, the regulator module being arranged to regulate the material in-feed to the screening module.

21. A system according to claim 20, wherein the regulator module comprises a container.

22. A system according to claim 21, wherein the container is a shipping container or an open frame.

23. A method for processing used drilling fluid to enable reuse of the fluid, the method comprising:
receiving a flow of used drilling fluid;
feeding the fluid flow to a screening system;
separating particles having a predetermined size classification from the fluid flow using multifrequency vibration; and
discharging processed drilling fluid.

24. A method according to claim 23, comprising spraying liquid onto the fluid flow during the separation step.

25. A method according to claim 23, wherein the step of separating particles includes feeding the fluid flow onto a screen of the screening system, and applying transient impact forces to the screen to induce multifrequency oscillations in the screen that excite the particles.

26. A method according to claim 25, wherein the transient impact forces are delivered by one or more vibrational adaptors that are excited by single frequency vibration.

27. A method according to claim 23, wherein the screening system is a screening module according to claim 1, or a modular containerized bulk material recovery system according to claim 16.

28. A method according to claim 24, wherein the step of separating particles includes feeding the fluid flow onto a screen of the screening system, and applying transient impact forces to the screen to induce multifrequency oscillations in the screen that excite the particles.
